(19) United States
(12) Patent Application Publication
(10) Pub. No.: US 2010/0161287 A1
(43) Pub. Date: Jun. 24, 2010

(54) MEASUREMENT DATA MANAGEMENT SYSTEM

(76) Inventors: Marc R. Sauerhoefer, Coventry, CT (US); Robert T. Brooks, Chuluota, FL (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/341,072

(22) Filed: Dec. 22, 2008

(51) Int. Cl. G06F 17/50; G01B 21/00; G01B 21/04

(52) U.S. Cl. 703/1; 702/155; 702/152

(57) ABSTRACT

A system and process for managing measurement data and generating production and engineering drawings from measurements obtained from a sample population parts to generates and parametrically update engineering and production drawings from measurement data of actual parts. The system and process provides efficient allocation of measurement resources to generate engineering drawings and models. The resources are allocated in a manner that eliminates and reduce time required for producing and generating usable engineering models and drawings.

### BACKGROUND OF THE INVENTION

A system and method of managing and implementing measurement data is disclosed. More particularly, a system and method for utilizing measurement data to generate part models and drawings is disclosed.

The generation of a part drawing and determination of tolerances from measurement data, from a physical population of parts, is a labor intensive process. Part data is typically determined by measuring specific dimensions and features. The measurement data is then utilized to produce drawings from which a part can be manufactured. However, this process is labor intensive as it requires selection of features of the part followed by measurement of a statistically relevant number of different parts to determine part tolerances and other information required to manufacture the parts.

Accordingly, it is desirable to design and develop a process for managing measurement data to reduce labor and time required to generate parameters specific to a part to enable manufacture.

### SUMMARY OF THE INVENTION

A disclosed example system and process manages measurement data and generates production and engineering drawings from measurements obtained from a representative sample part and generates and updates engineering and production drawings from subsequent measurement data sets from the part sample population.

Past processes for generating engineering drawings and models from measurement data are extremely labor-intensive and required extensive collection of data before generation of a sufficient part model or engineering drawing could be created. The example measurement data management system provides a system for significantly reducing the time required to generate engineering drawings from measurement data.

The example process begins with a first step of identifying primitive portions and shapes of a first example part. In this step, primitive features and shapes of the example part are defined in a library which represent the part as a combination of primitive shapes such as circles, rectangles and other simple features that are available in a feature-based design library. A feature based drawing is produced to provide a starting or initial outline of the part that identifies specific features and geometries that are later refined with further measurement data.

The feature based library defines the required input primitives needed to create a drawing. The feature library includes commonly utilized shapes and features applicable to the part being measured. An initial scanning defines a plurality of coordinate sets for various points of interest of the part. This series of coordinate points are utilized along with the standard feature-based library to define the outer dimension and configuration of the part. This initial scanning utilizes a single part to identify specific features and regions of the part to determine the overall geometry that is later refined with further measurements.

Upon completion of the initial model from first piece area and profile scanning of the part, a balloon drawing is generated that includes a plurality of parametric dimensions that are utilized to further define and clarify the part configuration. Each required or desired dimension is identified and associated with a balloon point in the drawing. The points identified are parametric dimensions that are updated and clarified as additional measurement data is obtained. These parametric dimensions are updated until a desired confidence level is obtained for each dimension.

Accordingly, the process and system of the example disclosed provides for the efficient allocation of measurement resources to generate engineering data and models. The resources are allocated in a manner that reduces time required for producing and generating usable engineering data, models and drawings.

These and other features of the present invention can be best understood from the following specification and drawings, the following of which is a brief description.

### BRIEF DESCRIPTION OF THE DRAWINGS

FIG. 1 is a flow diagram illustrating the process steps for the measurement data management system.

FIG. 2 is a schematic representation of the process steps for an example of the measurement data management system.

### DETAILED DESCRIPTION OF THE PREFERRED EMBODIMENT

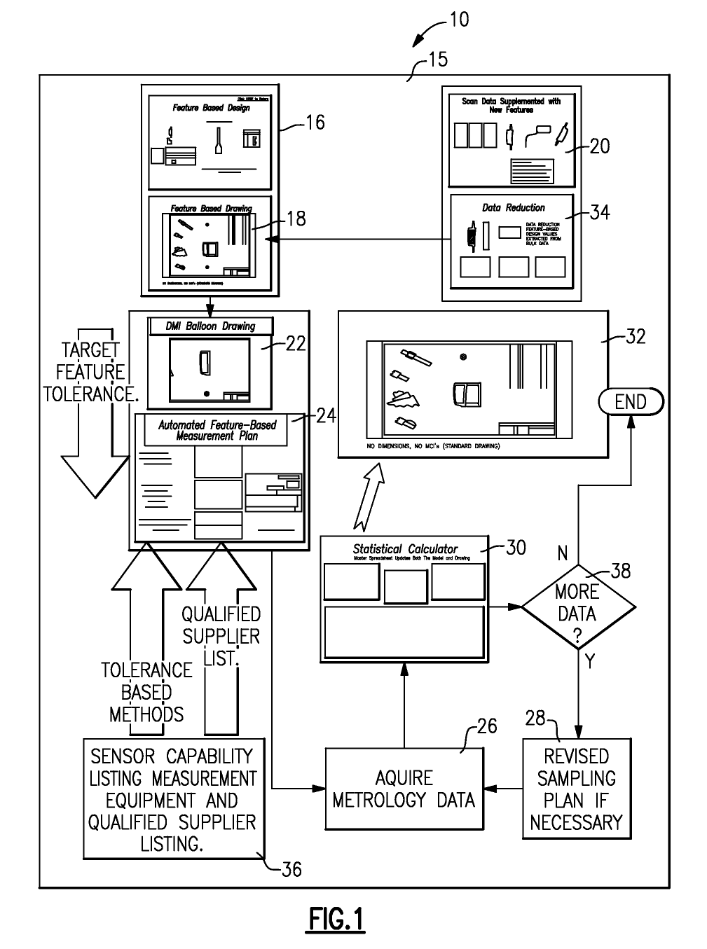

Referring to FIG. 1, a process and system for managing measurement data and generating production and engineering drawings from measurements obtained from a sample population part is schematically disclosed at 10. This process generates and updates engineering and production drawings from measurement data of actual parts. Past processes for generating engineering drawings and models from measurement data was extremely labor-intensive and required extensive collection of data before generation of a sufficient part model or engineering drawing could be created. The example measurement data management system 10 provides a system for significantly reducing the time required to generate and update engineering drawings from measurement data. The example system and process 10 includes a computing device 15 schematically shown here that provides support for executing the following processes.

The example system 10 performs the process and begins with an initial step indicated at 16 of identifying primitive portions and shapes of a first example part. In this step, primitive features and shapes of the example part are defined in order to represent the part as a combination of primitive shapes such as circles, rectangles and other simple features that are available in a feature-based design library. A feature based drawing indicated at 18, is produced to provide a starting or initial outline of the part that identifies specific features and geometries that are later refined with further measurement data.

The feature based library defines the required input needed to create the features based drawing 18. The drawing shown schematically at 18 represents the desired part configuration in a feature based environment. The features utilized to generate the initial drawing 18 are obtained from a standard feature library. The feature library includes commonly utilized shapes and features applicable to the part being measured. The specific features are identified from an initial scanning of the part as is indicated at 20.

The initial scanning of the part 20 includes an area scanning procedure that defines a plurality of coordinate sets for various points of interest of the part. In this process, the outer perimeter is defined by generating a plurality of coordinate point sets. This series of coordinate points are utilized along with the standard feature-based library to define the outer dimension and configuration of the part. The initial scanning provides systematic feature-based data and feature extraction from an initial first piece captured geometry. Both surface and feature scanning are used to define the features and details capturing a specific parts unique details and intricacies. This initial scanning utilizes a single part to identify specific features and areas of the part to determine the overall geometry that is later refined with further measurements. Further, a parametric feature-based library and set of design standards is utilized to obtain models and drawing primitives that provide a starting point.

Upon completion of the initial scanning of the part, a balloon drawing is generated as is indicated at 22. The balloon drawing includes a plurality of parametric dimensions that are utilized to further define and clarify the part configuration. Each required or desired dimension is identified and associated with a balloon point in the drawing. The points identified are parametric dimensions that are updated and clarified as additional measurement data is obtained. The drawing includes specific features that outline the dimensions and tolerances that are required in order to complete a part.

Further, the balloon drawing also identifies particular dimensions and tolerances. The dimensions are identified but not yet provided with actual measurement data. In the step of creating the balloon drawing 22, the required dimensions are identified and provided a place holder related to the part specific geometry. This process entails the systematic selection and labeling of identifiers that correspond to updatable parametric expressions. Each dimension includes the attributes and characteristics of the model and drawing associated with each identifier. The individual data points such as lengths, widths, and diameters are identified in a manner that communicates which parts and what measurement data is required to complete and provide the desired information to produce a part drawing or model.

Once the balloon drawing 22 is formulated utilizing the scanned data and the standard feature library, a measurement plan as is indicated at 24 is automatically output based on the identified features outlined in the ballooned drawings. The identified features and parametric dimensions provide a guide for the allocation and determination of what measurement data is required. Creation of the measurement plan 24 draws from sensor capability listings, qualified supplier listings, sensor capability listings, and other information and supplier and machine capability information indicated at 36. This listing and information provides a basis for optimizing a tolerance based method, and further selecting device or machine which is best capable of providing the information required to define the identifiers set out in the balloon drawing 22.

Each measurement point and geometric feature is evaluated to determine what level of measurement accuracy and precision is required. In some instances, the accuracy is not required to be of significant precision. However, other features of the part will require greater precision to provide statistically capable data. Accordingly, the measurement plan 24 allocates and assigns measurement processes and machines that are statistically capable of providing measurements to the precision required for each feature identified in the balloon drawing 22 of the part. Further the measurement plan includes instructions set out to obtain data supporting a target feature tolerance.

Once the measurement plan has been completed and determined for each of the specific features identified in the balloon drawing 22, the actual measurements are conducted for each feature as is indicated at 26. Measurements of a statistically significant number of parts are conducted. The specific measurement method, device and machine can be of any type known to a worker skilled in the art. A worker skilled in the art will be able identify applicable measurement techniques and machines required to obtain measurements that comply with the measurement plan.

Along with the allocation of measurement machines, according to the capability and statistical process capability required for each specific dimension, a determination is also made as to how many part measurements are required for each feature in order to provide a statistically significant sample population to obtain a desired level of confidence in the mean value and magnitude of deviations in the measurements.

Data obtained from the various measurement methods, is then directly input into a statistical calculator schematically indicated at 30. The statistically calculator system 30 is utilized to record data from each of the measurements based on the specific feature. The example statistical calculator system 30 is an electronic database. A worker skilled in the art would understand the program and implementation of software for the example statistical calculator 30. This data is then normalized for use to construct a drawing model as is indicated at 32. The drawing model 32 substitutes the updated parametric dimension originally identified in the balloon drawing 22 with actual geometric dimensioned and toleranced data.

The dimension and toleranced data for each feature is continually updated automatically as measurement data is input into the statistical calculator system 30. At each iteration of measurement data, a decision is made to determine if more measurement data is required as is schematically indicated at 38. Such iterative evaluation continues until a desired confidence level and tolerance are obtained.

The calculator system 30 is linked to the drawing model to provide a continuous updating of the drawing model 32 as new and additional measurement data is obtained that changes and clarifies a specific dimension. Further, this statistical calculator system 30 determines when a sufficient number of measurement points have been obtained to provide the desired confidence level. As appreciated, some features will require more inspection and measurement data in order to provide the desired confidence level as compared to other features.

Accordingly, the statistical calculator system 30 provides a means for determining when a statistically capable number of measurements have been made. This reduces the overall amount of measurements required thereby reducing the overall time required to produce a usable engineering drawing from measurement data. As additional data is input into the statistical calculator 30, the specific dimensions of the drawing model as are identified by the balloon drawing are updated. These updated dimensions represent the current best level of measurement data for each specific feature. Further, this information is updated and repeated as indicated by block 38 to provide an allocation of the confidence level in which the geometric dimensioning intolerances fall within application specific design requirements. Once the desired confidence level is obtained the drawing model 32 can be complete. However, additional data can always be input to further verify and improve the drawing model 32.

It should also be noted that a computing device or group of computing devices 15 can be used to implement various functionality of the process and system for managing measurement data and generating production and engineering drawings 10. In terms of hardware architecture, such a computing device 15 can include a processor, a memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device 15 is in operation, the processor can be configured to execute software stored within the memory, to communicate data to and from the memory, and to generally control operations of the computing device 15 pursuant to the software. Software in memory, in whole or in part, is read by the processor, perhaps buffered within the processor, and then executed.

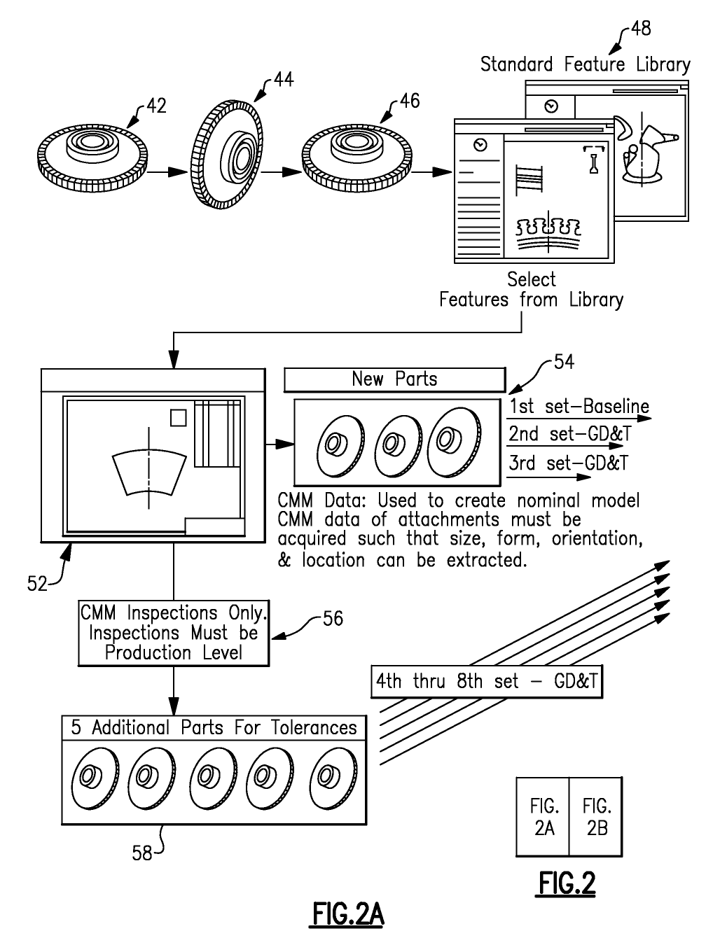

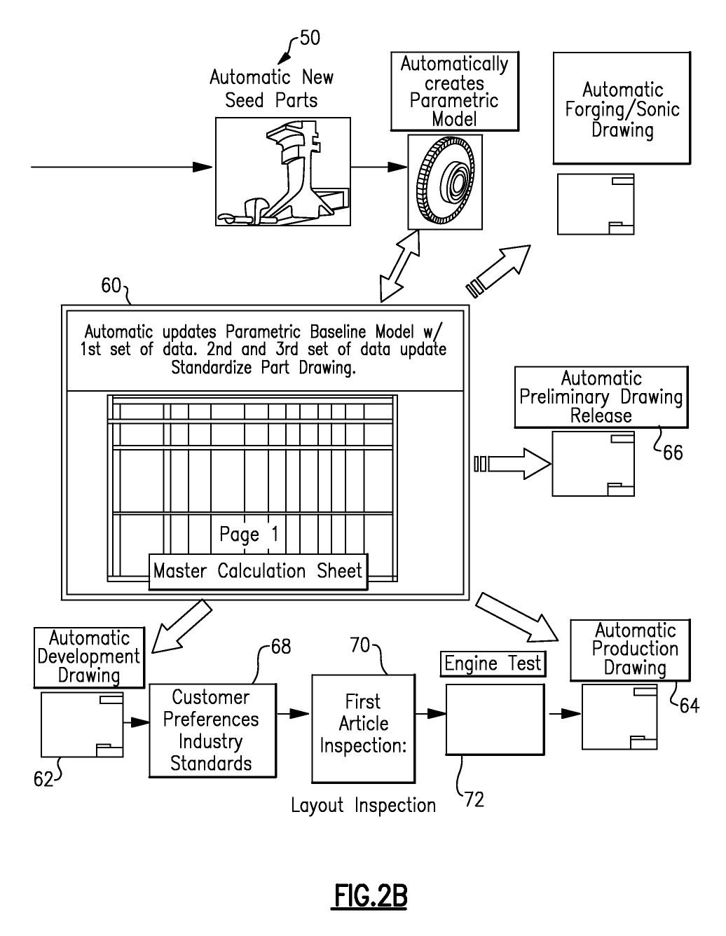

Referring to FIG. 2, which is an example of the method 10, here schematically illustrates the process beginning with a single new engine part 42. This process is applicable to any system or organization where drawings and models need to be generated from existing parts. In this process, a first step includes an area scan of the part 42. This area scan is combined with a feature library as is illustrated at 48 to generate a drawing from primitives shapes and features stored in a standard feature library.

Once a primitive or seed drawing is created, based on the area scan used and using the standard primitive feature library, other sections of other parts 44, 46 are utilized to further scan and specify features to further define and modify the part configuration and drawing.

The end result is a feature based drawing that is produced in concert with the area scanning of the part 42 and part sections 44, 46 along with the primitive or standard features already available. This data is utilized to create a drawing including parametric dimensions where significant features are indicated as a variable. The drawings produced by the area scanning of the part 42 in combination with the standard feature library produces a drawing where each of the dimensions are given a parametric value. This parametric value is utilized to generate and create a master calculation sheet 60. The master calculation sheet 60 includes a list of these parametric values. The parametric values are analyzed to determine what measurement devices and statistical confidence levels are required to provide sufficient information to produce the desired drawing within the desired accuracy and confidence levels.

The master calculation sheet 60 also provides means for developing an inspection plan including which machine or metrology process is required to provide the desired accuracy for each of the parametric values identified during the initial scan. The number of parts to be measured along with the specific process of measurement is determined and utilized to develop an inspection plan. In many instances, a coordinate measurement machine is utilized to measure specific points of a part. However, other measurement devices and machines may be required to obtain the desired accuracy for each of the identified parametric dimensions.

Acquired measurement data is input into the master calculation sheet 60. The master calculation sheet 60 updates each of the parametric dimensions in view of the added information. As is schematically shown at 58, additional data is input and directed to the master calculation sheet 60. This additional data provides further clarification and sampling to obtain the desired confidence level.

Once data is input into the calculation sheet, drawings can be generated that include preliminary dimensions based on currently available measurement data. As is indicated at 66, a preliminary drawing can be released. The preliminary drawing can be utilized to communicate the general dimensions of the part in advance of specific dimensions that meet desired confidence levels.

The calculation sheet 60 provides and does a statistical calculation on the inspection to provide a confidence level. Once the confidence level for any one of the parametric values that are generated for the drawing has been obtained the master calculation will provide indication so that further measurements are no longer required.

Upon the completion of measurement data that is within a desired confidence level of the calculation sheet 60 a completed drawing as is indicated at 62 can be developed. This drawing is continually updated with additional geometric dimensioning and tolerance data obtained from further layout inspections 70. Further, other inputs can be communicated through the calculation sheet 60. Other factors such as customer preferences or industry standards as are schematically illustrated at 68 can also provide an input into the calculation sheet to be integrated into the part drawings and measurement plans. Further, additional data that effect the formation of the part, such as for example results from engine testing, schematically indicated at 72, can be included and accommodated in the calculation sheet 60.

As should be appreciated, this process includes continuous measurements of additional parts until such time as a significant amount of variation is obtained to provide the statistical confidence level required to meet application specific requirements. Once this level is attained for each feature of a part, that feature is no longer scheduled for further measurement. Accordingly, instead of continual measurements of many parts resulting in vast amounts of data that may not be needed, this process provides a means of determining dimension by dimension when the confidence level goals are attained.

Accordingly, the process and system of the example disclosed provides for the efficient allocation of measurement resources to generate engineering and models. The resources are allocated in a manner that reduces time required for producing and generating usable engineering models and drawings.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of creating an engineering representation of a part comprising the steps of:
a) area and profile scanning a physical part;
b) defining features of the physical part based on the scanning of the physical part;
c) creating an engineering representation including the defined features;
e) defining a parametric expression for each defined feature;
f) obtaining measurement data for each defined feature; and
g) creating geometric dimensions and tolerances for each defined feature based on the parametric expressions utilizing the measurement data.

2. The method as recited in claim 1, including the step of measuring additional physical parts and updating the geometric dimensions and tolerances for at least some of the defined features based on the additional measurements.

3. The method as recited in claim 2, including the step of updating the parametric expression for at least some of the defined features based on the additional measurements.

4. The method as recited in claim 2, including the step of recording the measurement data according to an association with each identified feature and the parametric expression.

5. The method as recited in claim 1, wherein the step of defining features of the physical part comprises initially defining an outer perimeter of the physical part and defining coordinates for identified features of the physical part.

6. The method as recited in claim 5, wherein the step of defining features of the physical part comprises an area and profile scan of the physical part.

7. The method as recited in claim 1, wherein a first physical part is utilized to define the primitive shape and features for the engineering representation and subsequent ones of the physical part are measured to update the parametric expressions and geometric dimensions and tolerances.

8. The method as recited in claim 7, wherein the number of subsequent ones of the physical parts measured is determined to provide a desired inspection confidence level.

9. The method as recited in claim 1, including the step of associating each defined feature with a desired tolerance and assigning a measurement accuracy requirement to the identified feature.

10. The method as recited in claim 7, including the step of linking the measurement data to the engineering representation, and automatically updating the engineering representation based on recorded measurement data.

11. The method as recited in claim 10, wherein the measurement data is recorded in an electronic database, and further including the step of performing a statistical analysis on measurements for each feature to determine when a desired statically significant number of measurements have been completed.

12. The method as recited in claim 1, including the step of developing a measurement plan for each identified feature, wherein development of the measurement plan includes the step of assigning required measurement accuracy to each identified feature based on a desired measurement capability.

13. The method as recited in claim 12, including the specifying a measurement process based on the desired measurement capability.

14. The method as recited in claim 1, wherein the engineering representation comprises a three-dimensional model.

15. The method as recited in claim 1, wherein the engineering representation comprises an engineering drawing.

16. A system for creating engineering representation of a part comprising:
a first inspection device defining a first set of features of a part;
a microprocessor programmed for identifying a set of parametric features the part based on the first set of features;
a second inspection device for obtaining data for each of the parametric features; and
an output device for generating an engineering representation of the part based on the first set of features and the data for each of the parametric features.

17. The system as recited in claim 16, wherein the microcontroller includes a statistical calculator system for determining when a sufficient number of measurements have been obtained to meet a desired confidence level.

18. The system as recited in claim 16, wherein the microcontroller updates the parametric features with measurement data obtained form the second inspection device.

19. The system as recited in claim 16, including a feature library that includes pre-defined geometric shapes that are selected responsive to the defined first set of features of the part.

20. The system as recited in claim 16, wherein the first inspection device comprises a scanner that defines a plurality of coordinate sets for each feature of the part.

21. The system as recited in claim 16, wherein the second inspection device comprise one of a plurality of inspection machines selected depending to the parametric feature that is to be measured.
